(19) United States
(12) Patent Application Publication
(10) Pub. No.: US 2010/0097471 A1
(43) Pub. Date: Apr. 22, 2010

(54) AUTOMATED WAY TO EFFECTIVELY HANDLE AN ALARM EVENT IN THE SECURITY APPLICATIONS

(75) Inventors: Marine Drive, Bangalore (IN); Rajeshkumar Thappali Ramaswamy Sethuraman, Madurai (IN); Shanmugam Selvarajan, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/253,684

(22) Filed: Oct. 17, 2008

(51) Int. Cl. H04N 7/18

(52) U.S. Cl. 348/159

(57) ABSTRACT

A number of monitoring stations provide input surveillance video sequences and sensor signals to a remote facility such as a central monitoring station for further processing. A user interface at the remote facility allows a user to select a received input surveillance video sequence for summarization processing. A control at the remote facility summarizes the selected input surveillance video sequence into one or more video segments of shorter temporal duration. Video segments summarized from the selected input surveillance video sequence are displayed.

### FIELD OF THE INVENTION

The present invention relates to techniques, including methods, computer-readable storage media, surveillance systems, and user interfaces for summarizing input surveillance video sequences.

### BACKGROUND OF THE INVENTION

Various conventional surveillance systems are known to provide alarm event reporting and video monitoring.

In a conventional surveillance system, an operator located at a remote facility is notified of an alarm event upon the triggering of one or more sensors installed in monitored areas. The operator typically reviews the entire or a large portion of the recorded video sequence from a camera having a view of the area monitored by the triggered sensor to obtain information regarding what had occurred in the monitored area. The review process typically involves the operator determining a suitable playback position for the recorded video sequence and then reviewing the content of the video sequence starting from the playback position. This procedure is a manual procedure and may have to repeated one or more times for a particular video sequence. Additionally, operators typically work in environments where a single operator monitors multiple real-time video streams while also having to review multiple recorded video sequences.

### SUMMARY

A computer-based method for summarizing an input surveillance video sequence in accordance with a first implementation of the invention is described. In the first implementation, an input surveillance video sequence comprising a plurality of frames is received. In addition, a first frame, a second frame and a third frame is identified from the frames comprising the received input surveillance video sequence on the basis of a sensor triggering time point, an event cessation time point and a predetermined time point that is subsequent to the event cessation time point, respectively.

One or more computer-readable storage media having stored thereon a computer program in accordance with a second implementation of the invention is described. When executed by one or more processors, the computer program stored on the one or more computer-readable storage media causes the one or more processors to at receive an input surveillance video sequence, the input surveillance video sequence being comprised of a plurality of frames. The one or more processors are further caused to identify, from the frames comprising the received input surveillance video sequence, a first frame, a second frame and a third frame on the basis of a sensor triggering time point, an event cessation time point and a predetermined time point that is subsequent to the event cessation time point, respectively.

A surveillance system, in accordance with a third implementation of the invention, for summarizing at least one input surveillance video sequence, is described. The surveillance system is comprised of one or more processors configured to at least receive an input surveillance video sequence, the input surveillance video sequence comprising a plurality of frames, and to identify, from the frames comprising the received input surveillance video sequence, a first frame, a second frame and a third frame on the basis of a sensor triggering time point, an event cessation time point and a predetermined time point that is subsequent to the event cessation time point, respectively.

A user interface useable with one or more computing devices, in accordance with a fourth implementation of the invention is described. The user interface comprises a video sequence list of one or more video sequence labels representative of one or more input surveillance video sequences, the one or more input surveillance video sequences being available for summarization processing. The user interface further comprises a display window for displaying one or more video segments identified through the summarization processing of a selected input surveillance video sequence selected by the input surveillance video sequence selection mechanism. The user interface still further comprises an input surveillance video sequence selection mechanism for selecting an input surveillance video sequence displayed in the video sequence list, commanding the summarization processing of the selected input surveillance video sequence and commanding the displaying of the one or more video segments, identified through the summarization processing of the selected input surveillance video sequence in the display window.

### BRIEF DESCRIPTION OF THE DRAWINGS

FIG. 1 is a flow diagram illustrating an exemplary computer-implemented method for summarizing an input video sequence into video segments of shorter temporal duration than the input video sequence.

FIG. 2 is a flow diagram illustrating an alternative exemplary computer-implemented method for summarizing an input surveillance video sequence into video segments of shorter temporal duration.

FIG. 3 illustrates an arrangement with two monitoring systems in communication with a remote facility, according to a second embodiment of the invention.

FIG. 4 illustrates an overview of an exemplary monitoring system for monitoring a building location, according to a second embodiment of the invention.

FIG. 5 illustrates a remote facility, according to a second exemplary embodiment of the invention.

FIG. 6 shows a GUI (graphical user interface), according to a second exemplary embodiment of the invention.

FIG. 7 shows a display wall in addition to a GUI, according to a variation of a second exemplary embodiment of the invention.

### DETAILED DESCRIPTION OF THE EMBODIMENTS

An input surveillance video sequence is understood to be a sequence of frame images. A single image frame is understood to be the smallest unit making up an input surveillance video sequence. Further, a video segment is understood to be a number of consecutive frames within an input surveillance video sequence.

A sensor is understood to be an electronic device configured to measure at least one physical quantity and to convert the measured at least one physical quantity into at least one electrical signal. A sensor, for example, may measure motion, temperature, pressure, or loudness. A sensor is triggered when the physical quantity measured by the sensor exceeds a predetermined threshold. The time point at which the sensor is triggered is referred to as a sensor triggering time point. The sensor triggering time point marks the starting time point of a continuous duration of time referred to below as an alarm event. The ending time point of the alarm event will be referred to as an event cessation time point.

### First Embodiment

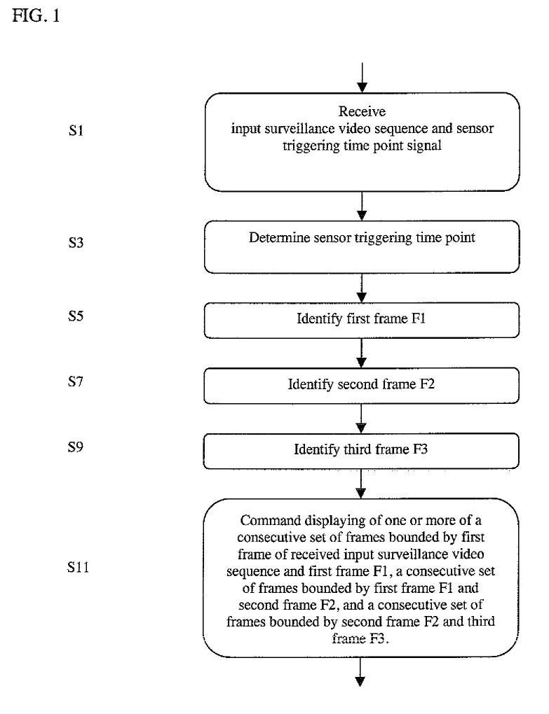

FIG. 1 is a flow chart illustrating a computer-implemented method, in accordance with a first exemplary embodiment of the invention, for summarizing an input surveillance video sequence into one or more video segments of shorter temporal duration.

The exemplary method can be implemented by a controller. A controller is understood to be a control logic known in the art, such as, one or more processors. A controller can also be implemented in software. The controller can be communicatively coupled, for example, to one or more sensors to receive signals indicating, for example, a sensor triggering time point. The controller can also be communicatively coupled to a video signal source to receive video signals.

In Step S1, the controller receives an input surveillance video sequence and a sensor triggering time point signal. The sensor triggering time point signal indicates a sensor triggering time point.

In Step S3, the controller then determines a sensor triggering time point from the received sensor triggering time point signal.

In Step S5, the controller then identifies a first frame F1 from the frames comprising the received input surveillance video sequence. The first frame F1 is identified on the basis of the sensor triggering time point.

In Step S7, the controller then identifies a second frame F2 that is associated with an event cessation time point from the frames comprising the received input surveillance video sequence.

As part of step S7, the controller identifies the second frame F2 by applying one or more frame comparison techniques. Frame comparison techniques have been developed and are known in the art. One example of such a technique is a color/brightness histogram comparison technique. Color/brightness histograms can be compared for successive frames in the received input surveillance video sequence. A second frame F2 (and an associated event cessation time point) that is subsequent in time to the first frame F1 can be identified, for example, when the difference in color/brightness between two successive frames exceeds a threshold. The threshold can be a predetermined threshold based on the type of sensor associated with the input surveillance video sequence.

As an alternative to applying one or more frame comparison techniques, the controller can receive an event cessation time point signal and determine from the signal, an event cessation time point. The event cessation time point in this case is a time point at which the physical quantity detected by the triggered sensor falls below a pre-determined threshold and therefore represents the ending time point of an alarm event. Accordingly, the second frame F2 is associated with the event cessation time point at which the physical quantity detected by the triggered sensor falls below a pre-determined threshold.

In Step S9, the controller then identifies a third frame F3 on the basis of a predetermined time point that is subsequent to the determined event cessation time point. The duration of time between the event cessation time point and the predetermined time point can be dependent, for example, upon the type of sensor associated with the input surveillance video sequence.

In Step S11, the controller then commands the displaying of one or more of a consecutive set of frames from the frames comprising the received input surveillance video sequence that is bounded by the first frame of the received input surveillance video sequence and the identified first frame F1, a consecutive set of frames from the frames comprising the received input surveillance video sequence that is bounded by the identified first frame F1 and the identified second frame F2, and a consecutive set of frames from the frames comprising the received input surveillance video sequence that is bounded by the identified second frame F2 and the identified frame F3.

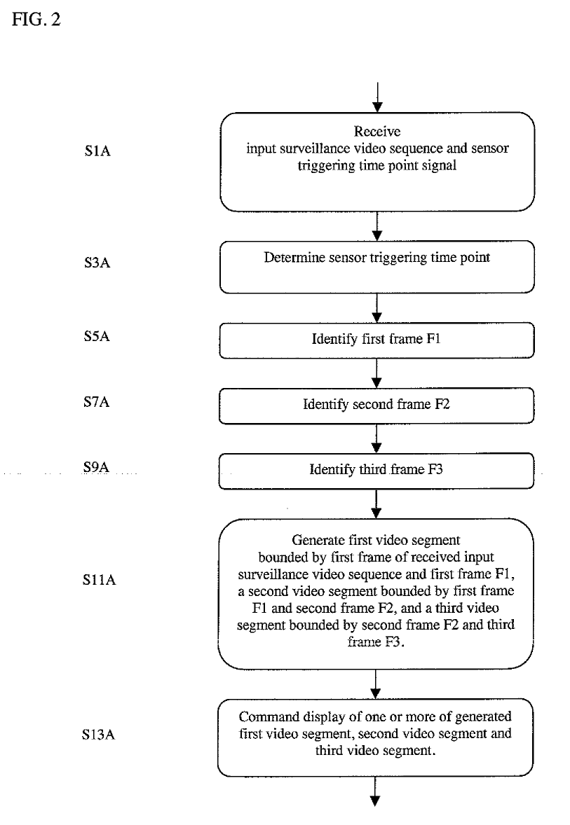

FIG. 2 is a flow chart illustrating an alternative exemplary method. Steps S1A to S9A in the alternative exemplary method are substantially similar to steps S1 to S9 in the above-described method. In Step S11A, the controller then generates a first video segment, a second video segment and a third video segment, from the frames comprising the input surveillance video sequence, on the basis of the identified first frame F1, second frame F2 and third frame F3.

The first video segment is bounded by the first frame of the received input surveillance video sequence and the identified first frame F1. The second video segment is bounded by the identified first frame F1 and the identified second frame F2. The third video segment is bounded by the identified second frame F2 and the identified third frame F3.

Furthermore, in Step S13A, the controller then commands the displaying of one or more of the generated first video segment, second video segment and third video segment.

The content of the first video segment provides an operator reviewing the first video segment (or the frames comprising a first video segment) with information relating to the area monitored by the triggered sensor for a duration of time ending at the sensor triggering time point. Effectively, it provides an operator with information on what had occurred in the monitored area prior to the alarm event. As an example, a first video segment associated with a motion sensor provides an operator with information regarding movement (or lack thereof) in the monitored area prior to the triggering of the motion sensor by threshold-exceeding movement.

The content of the second video segment provides an operator reviewing the second video segment (or the frames comprising a second video segment) with information relating to the area monitored by the triggered sensor for a time period starting at the sensor triggering time point and ending at the event cessation time point. Effectively, it provides an operator with information on what had occurred in the monitored area during the alarm event. As an example, a second video segment associated with a motion sensor provides an operator with information regarding movement in the monitored area during an intrusion alarm event.

The content of the third set of boundary frames provides an operator reviewing the third video segment (or the frames comprising a third video segment) with information relating to the area monitored by the triggered sensor for a predefined during after the event cessation time point. Effectively, the third video segment provides an operator with information on what had occurred in the monitored area after the alarm event.

In addition to the steps described above, the controller can engage in a higher-level summarization of the generated first, second and third video segments.

In an exemplary higher-level summarization step, one or more frames can be trimmed from the first, second and third video segments. For instance, one or more frames from the beginning of the first video segment can be excluded or the beginning boundary of the first video segment can be modified such that the resulting modified first segment will have a duration of a pre-determined length that is shorter than the original first video segment.

As another example, one or more key frames can be identified from each of the generated first, second and third video segments. A key frame is understood to be a characteristic frame of a video segment that is representative of the content of the video segment.

While the above-described exemplary methods are described with respect to input video data, the method is understood to be adaptable to data of multiple forms. For example, the exemplary method described herein may be adapted for a combination of input video and audio data.

### Second Embodiment

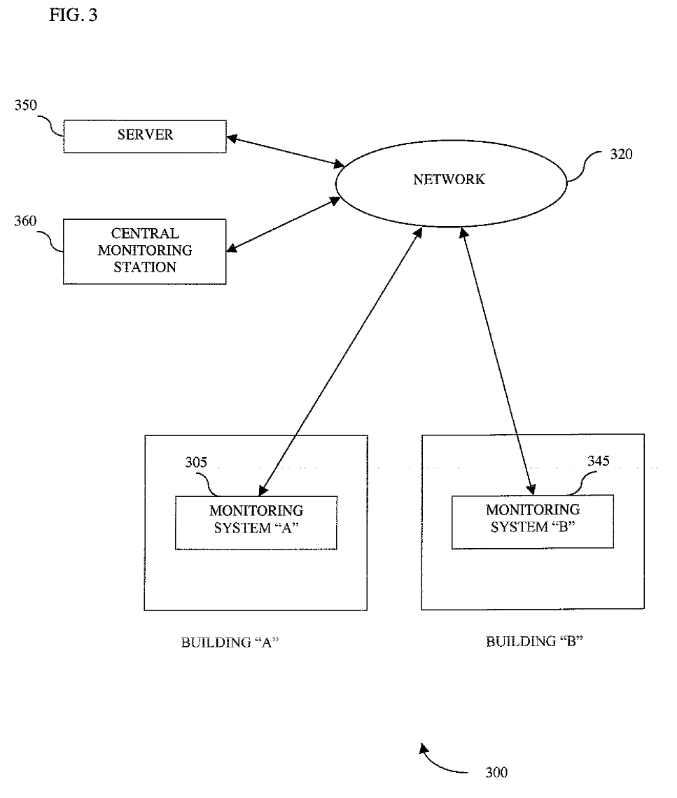

FIG. 3 provides an overview of a surveillance system according to a second exemplary embodiment of the invention. The surveillance system 300 comprises two monitoring systems 305 and 345 reporting to remote facilities 350 and 360. A first building location (building “A”) is monitored by the first monitoring system (monitoring system “A”) 305, while a second building location (building “B”) is monitored by the second monitoring system (monitoring system “B”) 345. The building locations may be separate structures, such as individual homes or business facilities. Alternatively, the building locations may be different parts of a common structure, such as different apartments in an apartment building, or different areas of a business, such as an office in a retail store or factory, and so forth. Note that the concept can be extended to more than two monitoring systems and building locations. For example, dozens of chain stores may be monitored. In a nationwide or worldwide scheme, separate monitoring systems may be provided in different geographic locations, if desired.

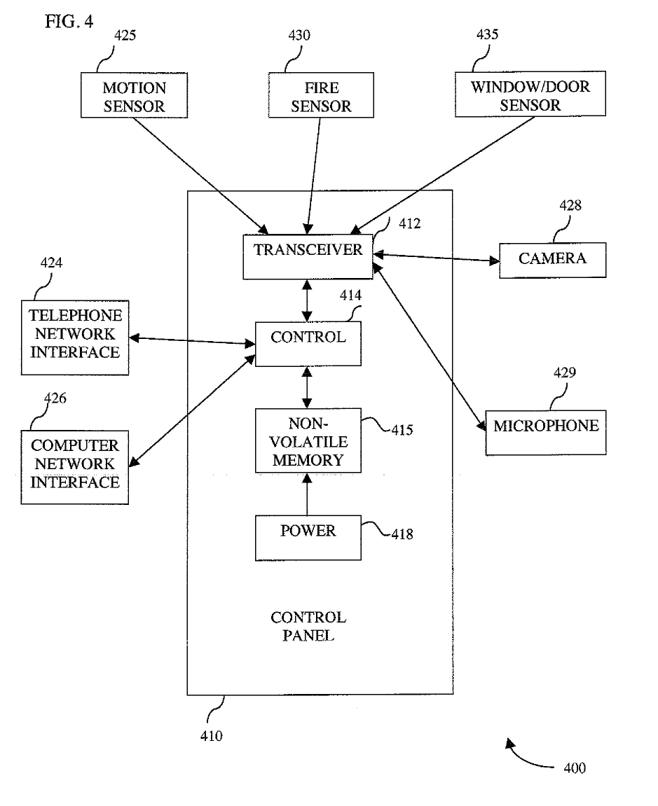

FIG. 4 illustrates an overview of an exemplary monitoring system for monitoring a building location. The monitoring system 400 includes a control panel 410 that communicates with a number of sensors via wired or wireless paths. The wireless paths may be RF paths, for instance. The control panel 510 may receive signals from motion sensor 425, fire sensor 430, and window and door sensor 435, for instance.

The control panel 410 includes a transceiver 412 for transmitting and receiving wireless signals. The control panel 410 further includes a control 414 that further includes a microprocessor that may execute software, firmware, micro-code or the like to implement logic to control the monitoring system 400. The control panel 410 may include a non-volatile memory 415 and other additional memory 416 as required. A memory resource used for storing software or other instructions that are executed by the control 414 to achieve the functionality described herein may be considered a computer-readable storage medium. A dedicated chip such as an ASIC may also be used. A power source 418 provides power to the control panel 410 and typically includes a battery backup to AC power.

A telephone network interface 424, such as a modem, allows the control panel 410 to send and receive information via a telephone link. A computer network interface 426 allows the control panel 410 to send and receive information via a computer network, such as the Internet. The computer network interface 426 may include an always-on interface, such as a DSL or cable modem, or a network interface card, for example. Alternatively, a dial-up telephone connection may be used. Other communication paths such as long-range radio and a cellular telephone link may also be used. The interfaces 424 and 426 are typically hardwired to the control panel 410 and activated by the control 414.

One or more cameras 428 may be used to provide image data, including still images or video, to the control 414 directly or via the transceiver 412. The image data is encoded and compressed for storage and/or transmission in a digital format. An appropriate storage medium such as a hard disk can be used to store the image data. The cameras can be positioned at various locations around the monitored building, including the exterior and interior. When a sensor is triggered, video and/or image data from the camera 428 that has a view of the area monitored by the triggered sensor can be stored and communicated to a remote facility for remote viewing and processing. Similarly, one or more microphones 429 can provide audio data from different locations around the monitored premises to the control 414 directly or via the transceiver 412. When a sensor is triggered, audio data from the microphones 429 that cover an area monitored by the triggered sensor can be stored and communicated to a remote facility for remote listening and processing.

It is also possible for a monitoring system to receive commands from the remote facility to control its cameras and microphones. For example, a camera may be mounted so that it can change its field of view, such as by zooming in or pivoting, via a motor control. In this case, such movements can be controlled remotely using an appropriate control and communication scheme. It is also possible to change the operating mode of a camera, such as by changing the rate or resolution at which it provides still frames, or switching from a still frame mode to a motion picture mode, or switching from a visible light mode to an infrared light mode, and so forth.

Referring back to FIG. 3, the relationship between the two monitoring systems (monitoring system “A” 305 and monitoring system “B” 345) and remote facilities 350 and 360 is discussed in further detail below.

The monitoring systems 305 and 345 each communicate with a remote facility, which can include a server 350 and/or central monitoring station 360, via one or more networks, such as network 320. The monitoring systems 305 and 345 can transmit video and audio data to the remote facilities 350 and 360. The monitoring systems 305 and 345 can also transmit signals from sensors to the remote facilities 350 and 360. For example, the signals can indicate whether a sensor has been triggered, a sensor triggering time point and an event cessation time point. The signals can further indicate their association with a particular input surveillance video sequence transmitted to the remote facility.

In one possible approach, all communications with the monitoring systems 305 and 345 are handled by the server 350, and the server 350 forwards the periodically updated information received from the monitoring systems 305 and 345 to the central monitoring station 360. In another possible approach, all communications with the security systems 305 and 345 are handled by the central monitoring station 360, which subsumes the functions of the server 350. In any case, the monitoring systems 305 and 345 can communicate with one or more remote facilities which include computers for storing and processing data.

The network 320 can include essentially any type of communication path or paths, including a telephone link, such as a conventional telephone network. In this case, signaling using a compatible modem may be used. In another approach, the network 320 includes a computer network such as the Internet or an intranet of a corporation or other organization. For instance, the monitoring systems 305 and 345 may use a communications protocol such as TCP/IP to communicate with the remote facilities 350 and 360. Other communication paths such as satellite or RF radio paths, including, e.g., those using GSM or CDMA techniques, may also be used. Moreover, the different monitoring systems may use different communication paths, and upstream communications to the server 350 or central monitoring station 360 may be on a different path than downstream communications. Similarly, the server 350 and the central monitoring station 360 may communicate via a different network or path than used by the monitoring systems 305 and 345. Data may also be communicated on redundant paths to provide additional security.

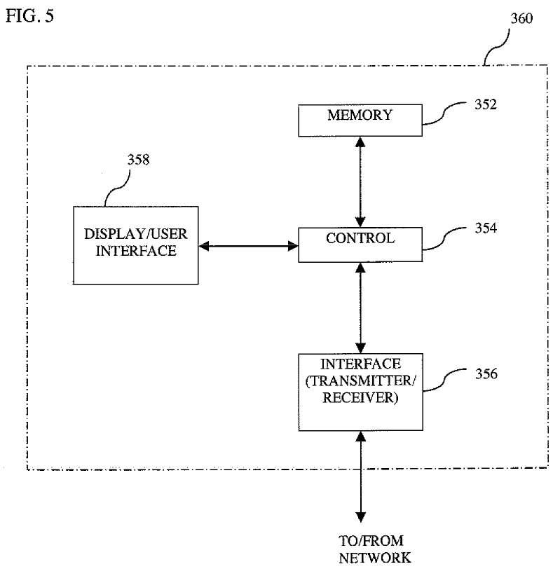

FIG. 5 illustrates a remote facility according to the second exemplary embodiment of the invention. The remote facility, illustrated as the central monitoring station 360, can include a general purpose computer that is programmed to achieve the functionality described herein. The remote facility 360 is typically a staffed facility that is remote from the monitoring systems which it serves. Multiple remote facilities may be provided as needed to serve groups of monitoring systems.

The remote facility 360 includes a communications interface 356, including a receiver and transmitter, for communicating with different monitoring systems and/or servers, such as server 350, via one or more networks.

The remote facility 360 further includes a control 354 used to execute software programs stored in the memory 352 to achieve the desired functionality described herein. A memory resource used for storing software programs or other instructions that are executed by the control 354 to achieve the functionality described herein may be considered a computer-readable storage media.

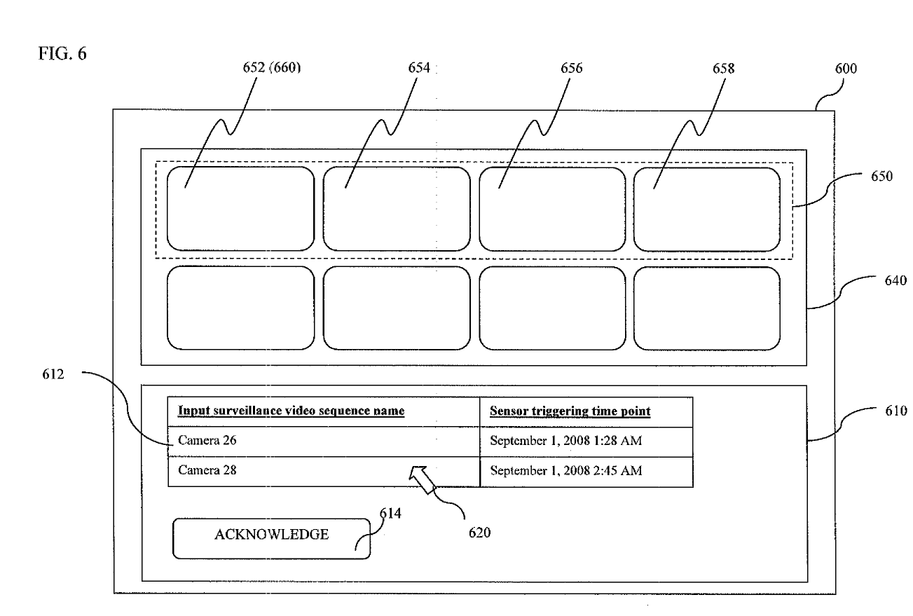

The remote facility 360 further includes one or more displays 358. As illustrated in FIG. 6, a graphical user interface (GUI) 600 can be generated on the one or more displays 358 by executing software instructions on a computer. The GUT 600 can be interactive in that it displays information and also receives commands from an operator. Any suitable scheme may be provided that allows the operator to interact with the user interface 600.

GUI 600 includes an interior window 610 that is a list view of input surveillance video sequences received by remote facility 360. Each input video sequence listed in interior window 610 is represented as a video sequence label 612. The sensor triggering time point associated with the listed input surveillance video sequence may also be listed in interior window 610.

GUI 600 supports one or more mechanisms for selecting an input surveillance video sequence displayed in the video sequence list, commanding the summarization processing of the selected input surveillance video sequence and commanding the displaying of the one or more video segments, identified through the summarization processing of the selected input surveillance video sequence, in the display window.

An example of such a mechanism is an acknowledgment button function. Using this function, an operator first “clicks” on a listed input surveillance video sequence (i.e., positioning a cursor 620 on a video sequence label 612 and then depressing and releasing a button, such as a mouse's button while the cursor 620 remains positioned on the particular video sequence label 612) to select one of the listed input video sequences and then “clicks” an “Acknowledge” button provided in the GUI to command the summarizing of the selected input surveillance video sequence.

In another example, GUI 600 provides a “drag-and-drop” function. Using the “drag-and-drop” function, an operator selects a listed input surveillance video sequence with a mouse by positioning a cursor 620 on a video sequence label 612 and depressing the mouse button while the cursor 620 remains positioned on the video sequence label 612, and dragging the video sequence label 620 while still depressing the mouse button, to the display window 640 where the mouse button is then released.

Referring again back to FIG. 5, following the selection of an input surveillance video sequence, control 354 executes the software programs stored in memory 352 to identify a first frame F1, a second frame F2, and a third frame F3 from the frames comprising the selected input surveillance video sequence for summarization processing.

The first frame F1 is identified on the basis of the sensor triggering time point. The second frame F2 that is associated with an event cessation time point is then identified. As described above, the event cessation time point can be determined, for example, by applying one or more frame comparison techniques. The third frame F3 is then identified on the basis of a predetermined time point that is subsequent to the determined event cessation time point.

Following the identification of the first frame F1, second frame F2 and third frame F3 from the frames comprising the selected input surveillance video sequence, the control 354 then commands the displaying of one or more temporally consecutive set of frames from the frames comprising the selected input surveillance video sequence. For example, the controller can command the displaying of a first set of temporally consecutive frames that is bounded by the first frame of the received input surveillance video sequence and the identified first frame F1. The controller can further command the displaying of a second set of temporally consecutive frames that is bounded by the identified first frame F1 and the identified second frame F2. Still further, the controller can command the displaying of a third set of temporally consecutive frames that is bounded by the identified second frame F2 and the identified third frame F3.

As an alternative to commanding the displaying of one or more temporally consecutive set of frames from the frames comprising the selected input surveillance video sequence, as described above, the control 354 can generate a first video segment, a second video segment and a third video segment from the frames comprising the selected input surveillance video sequence.

The first video segment is bounded by the first frame of the selected input surveillance video sequence and the identified first frame F1. The second video segment is bounded by the identified first frame F1 and the identified second frame F2. The third video segment is bounded by the identified second frame F2 and the identified third frame F3. The control 354 then commands the displaying of one or more of the generated first video segment, second video segment and third video segment.

As further illustrated in FIG. 6, a display window 640 is provided in the GUI for displaying video segments summarized from one or more input surveillance video sequences. Video segments can be displayed in display window 640 in a tiled fashion such that the video segments summarized from a single input surveillance video sequence are displayed in a single row 650 of video view ports 652, 654, 656 and 658.

Furthermore, the temporal order of video summarized from a single input surveillance video sequence can be represented by spatial order in display window 640.

For example, a first video segment containing content related to a period of time prior to the sensor triggering time point, a second video segment containing content related to a period between the sensor triggering time point and the event cessation time point, and a third video segment containing content related to a period between the event cessation time point and the event acknowledgment time point can be displayed in order in a single row from left to right in video view ports 652, 654 and 656 to represent the temporal order of each video segment within the summarized input surveillance video sequence.

In addition to displaying the video segments summarized from an input surveillance video sequence in a single row, real-time video stream from the camera that captured the summarized input surveillance video sequence can also be displayed in video view port 658 in the display window 640.

Furthermore, each video segment to be displayed in display window 640 can be represented by a thumbnail 660 displaying a key frame image from which an operator may recall the content of the particular video segment associated with the key frame. By clicking the thumbnail, an operator can command the display of the selected video segment from within display window 640.

Display window 640 is further configured to permit an operator to switch between a video segments view mode (for displaying video segments summarized from an input surveillance video sequence, as described above) and a general surveillance view mode. In the general surveillance view mode, the operator can monitor real-time video streams from multiple cameras with each video stream displayed in a video view port arranged in display window 640.

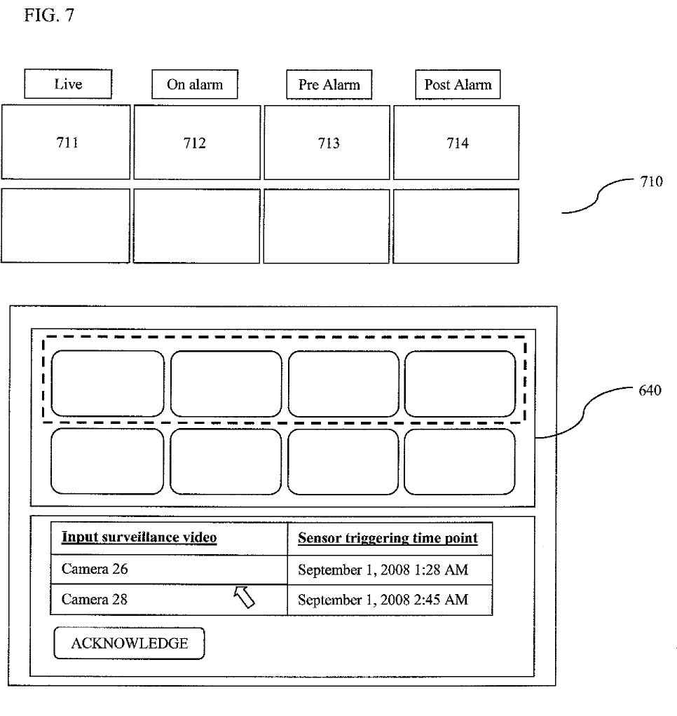

In addition to (or as an alternative to) displaying video segments summarized from one or more input surveillance video sequences in display window 640 in the GUI, video segments can be displayed on a display wall as illustrated in FIG. 7. Display wall 710 is comprised of multiple displays 711, 712, 713 and 714 tiled in a user-designated configuration.

The invention has been described herein with reference to particular exemplary embodiments. Certain alterations and modifications may be apparent to those skilled in the art, without departing from the scope of the invention. The exemplary embodiments are meant to be illustrative, not limiting the scope of the invention, which is defined by the appended claims.

What is claimed is:

1. A computer-based method comprising:
receiving an input surveillance video sequence, the input surveillance video sequence being comprised of a plurality of frames;
identifying a first frame F1 from the frames comprising the received input surveillance video sequence, the first frame F1 being determined on the basis of a sensor triggering time point;
identifying a second frame F2 from the frames comprising the received input surveillance video sequence, the second frame F2 being determined on the basis of an event cessation time point; and
identifying a third frame F3 from the frames comprising the received input surveillance video sequence, the third frame F3 being identified on the basis of a predetermined time point that is subsequent to the event cessation time point.

2. The computer-based method as recited in claim 1, further comprising:
receiving a sensor triggering time point signal, the sensor triggering time point signal indicating a sensor triggering time point.

3. The computer-based method as recited in claim 1,
wherein identifying the second frame F2 from the frames comprising the received input surveillance video sequence further comprises applying one or more frame comparison techniques to identify the event cessation time point.

4. The computer-based method as recited in claim 1, further comprising:
receiving an event cessation time point signal, the event cessation time point signal indicating an event cessation time point.

5. The computer-based method as recited in claim 1, further comprising:
commanding the display of one or more of:
a first consecutive set of frames from the frames comprising the received input surveillance video sequence, the first consecutive set of frames being bounded by the first frame of the received input surveillance video sequence and the identified first frame F1;
a second consecutive set of frames from the frames comprising the received input surveillance video sequence, the second consecutive set of frames being bounded by the identified first frame F1 and the identified second frame F2; and
a third consecutive set of frames from the frames comprising the received input surveillance video sequence, the third consecutive set of frames being bounded by the identified second frame F2 and the identified third frame F3.

6. The computer-based method as recited in claim 1, further comprising:
generating one or more of:
a first video segment, the first video segment being bounded by an end frame that is associated with the identified first frame F1;
a second video segment, the second video segment being bounded by a start frame that is associated with the identified first frame F1 and an end frame that is associated with the identified second frame F2; and
a third video segment, the third video segment being bounded by a start frame that is associated with the identified second frame F2 and an end frame that is associated with the identified third frame F3.

7. The computer-based method as recited in claim 6, further comprising:
commanding the display of one or more of the generated first video segment, second video segment and third video segment.

8. One or more computer-readable storage media having stored thereon a computer program that when executed by one or more processors, causes the one or more processors to at least:
receive an input surveillance video sequence, the input surveillance video sequence being comprised of a plurality of frames;
identify a first frame F1 from the frames comprising the received input surveillance video sequence, the first frame F1 being determined on the basis of a sensor triggering time point;
identify a second frame F2 from the frames comprising the received input surveillance video sequence, the second frame F2 being determined on the basis of an event cessation time point; and
identify a third frame F3 from the frames comprising the received input surveillance video sequence, the third frame F3 being determined on the basis of a predetermined time point that is subsequent to the event cessation time point.

9. The one or more computer-readable storage media as recited in claim 8, having stored thereon a computer program that, when executed by the one or more processors, further causes the one or more processors to:
receive a sensor triggering time point signal, the sensor triggering time point signal indicating a sensor triggering time point.

10. The one or more computer-readable storage media as recited in claim 8, having stored thereon a computer program, wherein to identify the second frame F2 from the frames comprising the received input surveillance video sequence, the one or more processors in executing the computer program, are caused to further apply one or more frame comparison techniques to identify the event cessation time point.

11. The one or more computer-readable storage media as recited in claim 8, having stored thereon a computer program that, when executed by the one or more processors, further causes the one or more processors to:
receive an event cessation time point signal, the event cessation time point signal indicating an event cessation time point.

12. The one or more computer-readable storage media as recited in claim 8, having stored thereon a computer program that, when executed by the one or more processors, further causes the one or more processors to:
command the display of one or more of:
a first consecutive set of frames from the frames comprising the received input surveillance video sequence, the first consecutive set of frames being bounded by the first frame of the received input surveillance video sequence and the identified first frame F1;
a second consecutive set of frames from the frames comprising the received input surveillance video sequence, the second consecutive set of frames being bounded by the identified first frame F1 and the identified second frame F2; and
a third consecutive set of frames from the frames comprising the received input surveillance video sequence, the third consecutive set of frames being bounded by the identified second frame F2 and the identified third frame F3.

13. The one or more computer-readable storage media as recited in claim 8, having stored thereon a computer program that, when executed by the one or more processors, further causes the one or more processors to:
generate one or more of:
a first video segment, the first video segment being bounded by an end frame that is associated with the identified first frame F1;
a second video segment, the second video segment being bounded by a start frame that is associated with the identified first frame F1 and an end frame that is associated with the identified second frame F2; and
a third video segment, the third video segment being bounded by a start frame that is associated with the identified second frame F2 and an end frame that is associated with the identified third frame F3.

14. The one or more computer-readable storage media as recited in claim 8, having stored thereon a computer program that, when executed by the one or more processors, further causes the one or more processors to:
command the display of one or more of the generated first video segment, second video segment and third video segment.

15. A surveillance system for summarizing at least one input surveillance video sequence, the system comprising:
one or more processors configured to at least:
receive an input surveillance video sequence, the input surveillance video sequence being comprised of a plurality of frames
determine a first frame F1 from the frames comprising the received input surveillance video sequence, the first frame F1 being determined on the basis of a sensor triggering time point; and
determine a second frame F2 from the frames comprising the received input surveillance video sequence, the second frame F2 being determined on the basis of an event cessation time point; and
determine a third frame F3 from the frames comprising the received input surveillance video sequence, the third frame F3 being determined on the basis of a predetermined time point that is subsequent to the event cessation time point.

16. The surveillance system in claim 15, further comprising:
one or more input surveillance video sequence source, the one or more processors being configured to receive one or more input surveillance video sequence from the one or more input surveillance video sequence source; and
one or more sensor triggering time point source, the one or more processors being configured to receive one or more sensor triggering time point signals from the one or more sensor triggering time point source, each sensor triggering time point signal indicating a sensor triggering time point.

17. The surveillance system in claim 15, the one or more processors being further configured to apply one or more frame comparison techniques to identify the event cessation time point.

18. The surveillance system in claim 15, further comprising:
an event cessation time point signal source, the one or more processors being configured to receive one or more event cessation time point signals, each event cessation time point signal indicating an event cessation time point.

19. The surveillance system in claim 15, further comprising
one or more displays, wherein the one or more processors are further configured to command the displaying on the one or more displays, one or more of:
a first consecutive set of frames from the frames comprising the received input surveillance video sequence, the first consecutive set of frames being bounded by the first frame of the received input surveillance video sequence and the identified first frame F1;
a second consecutive set of frames from the frames comprising the received input surveillance video sequence, the second consecutive set of frames being bounded by the identified first frame F1 and the identified second frame F2; and
a third consecutive set of frames from the frames comprising the received input surveillance video sequence, the third consecutive set of frames being bounded by the identified second frame F2 and the identified third frame F3.

20. The surveillance system in claim 15,
wherein the one or more processors are further configured to generate one or more of:
a first video segment, the first video segment being bounded by an end frame that is associated with the identified first frame F1;
a second video segment, the second video segment being bounded by a start frame that is associated with the identified first frame F1 and an end frame that is associated with the identified second frame F2; and
a third video segment, the third video segment being bounded by a start frame that is associated with the identified second frame F2 and an end frame that is associated with the identified third frame F3.

21. The surveillance system in claim 15, further comprising
one or more displays,
wherein the one or more processors are further configured to command the displaying on the one or more displays, one or more of the generated first video segment, second video segment and third video segment on the one or more displays.

22. A user interface useable with one or more computing devices, the user interface comprising:
a video sequence list of one or more video sequence labels representative of one or more input surveillance video sequences, the one or more input surveillance video sequences being available for summarization processing;
a display window for displaying one or more video segments identified through the summarization processing of a selected input surveillance video sequence; and
an input surveillance video sequence selection mechanism for selecting an input surveillance video sequence displayed in the video sequence list, commanding the summarization processing of the selected input surveillance video sequence and commanding the displaying in the display window of the one or more video segments summarized from the selected input surveillance video sequence.

23. The user interface of claim 22,
wherein the one or more video segments summarized from the selected input surveillance video sequence selected by the input surveillance video sequence selection mechanism is displayed in the display window in a grid format.

24. The user interface of claim 23,
wherein the temporal order of the one or more video segments displayed in the display window in grid format is represented in spatial order.

25. The user interface of claim 22,
wherein the input surveillance video sequence selection mechanism includes an acknowledgment button function for selecting an input surveillance video sequence displayed in the video sequence list, commanding the summarization processing of the selected input surveillance video sequence and commanding the displaying in the display window of the one or more video segments summarized from the selected input surveillance video sequence.

26. The user interface of claim 22,
wherein the input surveillance video sequence selection mechanism includes a drag-and-drop function for selecting an input surveillance video sequence displayed in the video sequence list, commanding the summarization processing of the selected input surveillance video sequence and commanding the displaying in the display window of the one or more video segments summarized from the selected input surveillance video sequence.

27. The user interface of claim 22,
wherein the one or more video segments summarized from a selected input surveillance video sequence includes one or more of
a first video segment, the first video segment being at least bounded by an end frame, the end frame being determined on the basis of a sensor triggering time point;
a second video segment, the second video segment being bounded by a start frame that is determined on the basis of the sensor triggering time point and an end frame that is determined on the basis of an event cessation time point; and
a third video segment, the third video segment being bounded by a start frame that is determined on the basis of the event cessation time point and an end frame that is determined on the basis of a predetermined time point that is subsequent to the event cessation time point.

28. The user interface of claim 22,
wherein the display window is further configured for displaying a real-time video stream from a camera associated with a selected input surveillance video sequence.
